(19) United States
(12) Patent Application Publication
(10) Pub. No.: US 2008/0228770 A1
(43) Pub. Date: Sep. 18, 2008

(54) Method for Performing Recoverable Live Context Migration in a Stacked File System

(76) Inventors: Michael A. Halcrow, Pflugerville, TX (US); Steven M. French, Austin, TX (US)

Correspondence Address: HAMILTON & TERRILE, LLP;IBM Austin, P.O. BOX 203518, AUSTIN, TX, 78720, US

(21) Appl. No.: 11/686,696

(22) Filed: Mar. 15, 2007

(51) Int. Cl. G06F 17/30

(52) U.S. Cl. 707/8

(57) ABSTRACT

A method, system and program are provided for selectively managing data migration in a stacked filesystem that receives a request to migrate a data file to a destination context, where the data file is divided into a plurality of sub-regions such that data stored in different sub-regions may have different contexts. In response to the migration request, file data is sequentially migrated, one sub-region at a time, to the destination context by maintaining context status information for each sub-region in a metadata portion of the data file, where the context status information prevents another application from accessing any sub-region in the data file that is being migrated, but allows access to other sub-regions in the data file.

### BACKGROUND OF THE INVENTION

1. Field of the Invention

The present invention is directed in general to the field of data processing systems and methods for managing and controlling data storage resources. In one aspect, embodiments of the present invention provide a method, system, and program for managing and controlling data transformation or migration in a file system or other file-based data storage system, such as a stacked file system.

2. Description of the Related Art

Data processing systems and the applications that run on them rely on memory to hold and store program instructions and data, where the memory may be classified as primary storage (e.g., the part of the memory that is immediately accessible by the computer or microprocessor) and secondary storage (e.g., storage devices such as magnetic disk drives, optical drives, etc.). Secondary storage devices are typically accessed and organized by programs or other components of the operating system using a higher-level interface called a filesystem. A filesystem is a set of abstract data types that are implemented for the storage, hierarchical organization, manipulation, navigation, access, and retrieval of data. In a filesystem, the storage resource is organized into directories, files, and other objects, each of which typically includes a name, a metadata portion (such as owner, size, content type and checksum), and a contents or data portion. Through the mapping function provided by the directories, a hierarchical structure or tree of directories and files is formed which may be navigated by a filesystem client (such as a program) to locate a particular file or directory. Conventional filesystems implement a limited set of operations (such as create, open, read, write, close, delete) on each of the objects contained in the filesystem in accordance using a predetermined format of instructions and data.

To help resolve potential conflicts between different types of filesystems, an abstraction layer above the filesystems, such as a virtual filesystem (VFS), may be used to allow program applications to access different types of filesystems in a uniform way that is transparent to the program application. In operation, a VFS specifies an interface between the kernel and a filesystem which allows access to different types of filesystems so long as the requirements of the interface are met. Even when a VFS is provided, there continue to be compatibility problems associated with filesystem development issues, such as difficulties associated with extending or re-using existing filesystems, and development and maintenance problems associated with evolution of filesystem interfaces. To address these problems, stackable filesystems have been designed which take multiple filesystems and produce a merged logical view of those filesystems on a given filesystem client. In a stackable filesystem, a single filesystem from a collection of logically joined filesystems is designated as the primary or “upper” filesystem “layer” in the stack, also referred to as the stacked filesystem layer. Stacked filesystems can perform arbitrary transformations on the contents of files as they pass through the stacked filesystem layer as it performs reads and writes on the underlying or “lower” files. However, existing stacked filesystems typically lock the entire lower file during any read, write or transformation operation so that the entire file can be protected during the transformation. If the entirety of the file being transformed is locked, other program applications are prevented from accessing the file. This can cause significant memory access conflicts and delays while the transformation process completes, especially if the file is large and/or if the file is frequently accessed.

Some stacked filesystems have attempted to address the memory latency problem by having the upper filesystem layer transform portions of the lower filesystem and pass the transformed portions of data up to the VFS as the transformation of each portion is completed. For example, the eCryptfs filesystem for Linux (authored by Michael Halcrow) is an example of a stacked filesystem that transforms the contents of a file (instead of the entire filesystem) when performing transparent page encryption and decryption as the file contents are read and written. Rather than encrypt the filesystem as a whole, eCryptfs deals with each file individually so that different files can be encrypted in different ways. To identify how each file is encrypted, eCryptfs maintains metadata on how each file is to be handled and stores this metadata in the first block of the file itself. As a result, the file can be backed up, copied, and even moved to another system without losing the metadata needed to decrypt it in the future. In operation, the upper or stacked filesystem layer acts as a translation layer on behalf of an application to request a particular file from a lower filesystem layer. The upper filesystem receives a request from the VFS (such as a system call to read data from a file) and transforms the request into one or more requests that are submitted in the appropriate format to the lower filesystem layer(s). The lower filesystem layer performs the submitted request(s) and provides a response to the upper filesystem layer, such as by retrieving encrypted data from the file and passing it up to the upper filesystem layer. The upper layer can then further process the response, such as by transforming the encrypted data into unencrypted data, and then return the transformed data to the VFS as it is transformed. While such an approach can reduce the memory latency that would be caused by having the upper filesystem layer transform the entire file before passing it up, it does not solve the data access problem caused by locking the entirety of the lower filesystem objects being transformed. In addition to memory latency concerns, existing stacked filesystems must also deal with other issues relating to data storage and transformation, such as data security, data compression, data recovery and conflicts during concurrent accesses.

Accordingly, there is a need for a system and method of transforming data in a filesystem that is flexible and transparent to the user. In addition, there is a need for an improved method, apparatus, and computer instructions for reducing memory latency problems associated with conventional approaches for protecting an entire filesystem during transformation of the data. There is also a need for a data transformation mechanism which allows data to be efficiently encrypted, compressed and recovered, all without creating unnecessary data access conflicts or lockouts. Further limitations and disadvantages of conventional filesystem solutions will become apparent to one of skill in the art after reviewing the remainder of the present application with reference to the drawings and detailed description which follow.

### SUMMARY OF THE INVENTION

A file-based data storage and management system and methodology are provided which enable different regions of a file to be separately transformed, accessed and/or recovered on-the-fly on the basis of context information that is maintained for each file region and stored within the file. Various embodiments of the present invention may be used with any desired type of data transformation (such as data compression/decompression, data reformatting, data encryption, etc.), though in an example embodiment described here, the data transformation involves the re-encryption of stored data from a first encrypted format (e.g., where data is encrypted using a DES cipher) to a second encrypted format (e.g., where data is encrypted using another cipher, such as a Blowfish, AES or Twofish cipher). For example, encrypted data stored in a file may be recoverably transformed without locking the entire file (and thereby disrupting access to the file by other applications) by using an upper filesystem layer to separately control and track the status of sub-regions within the file. Differentiated control and treatment of sub-regions within a file are supported by maintaining dynamic metadata in each file that describes the status of each sub-region, where the status information for the data in each sub-region may be referred to as the “context” for that data. In this way, the contents of a file may have a different “context” representation for each sub-region of the file. By separately tracking, updating and otherwise processing these representations, the stacked filesystem can transparently migrate data from one format to another on a customer machine while minimizing disruption to access to the individual files during the migration. In addition, by correlating each context with its sub-region during any data transformation event, the stacked filesystem can recover a “live” data transformation in the event of system failure during the transformation by using the context information to recover and to continue with the migration. While any desired correlation technique may be used, in an example bitmap implementation, bit vectors are used to track the context of each sub-region in a file, wherein each bit in the bit vector corresponds with a fixed-size sub-region of the file that corresponds with the position of the bit in the bit vector. In this example, there is a bit vector for each context present in the file. For example, if all of the data sub-regions in a file are DES-encrypted, then there is a single context for that file (namely, a “DES” context) and a single bit vector associated with that context. If there are two types of encryption used to encrypt the data sub-regions (e.g., DES and Blowfish), then there are two contexts (e.g., a “DES” context and a “Blowfish” context) and each context has its own bit vector. When the bit is set in a bit vector for any given context, the corresponding sub-region of the file is manipulated according to that context. In another example implementation, scatterlists are used to track the context of each sub-region in a file. With this approach, each scatterlist element delineates a variable-size sub-region of the file. The data may be organized such that each context maintains a list of scatterlist elements. Another possibility is that each of the scatterlist elements maintains a reference to the context for that region.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 illustrates a data processing system architecture in which selected embodiments of the present invention may be implemented;

FIG. 2 depicts a stacked filesystem architecture in accordance with selected embodiments of the present invention that is used to control encrypted data transformation within sub-regions of a file; and

FIG. 3 is a logical flowchart of the steps used to control data transformation and recovery within sub-regions of a file in accordance with selected embodiments of the present invention.

### DETAILED DESCRIPTION

A method, system and program are disclosed for performing live context migration in a stacked file system, such as the eCryptfs file system for Linux, which automatically formats the file contents (e.g., into an encrypted or decrypted format) as the file contents are written or read. By using bit vectors or scatterlists to separately track and control the format status of sub-regions within a file, portions of a file that are stored in a first encrypted state may be transparently migrated into a second encrypted state without locking the entire file against access by other programs during migration. In selected embodiments, context information for each file sub-region is stored as metadata in the file and used by an upper filesystem layer to selectively transform file data on a sub-region by sub-region basis. With this arrangement, the upper filesystem layer can transform or migrate a first file sub-region from a first context (e.g., DES-encrypted data) to a second context (e.g., Blowfish-encrypted data), without preventing access to a second file sub-region by another application. In addition, by updating the context information to reflect the status of a data migration operation for a sub-region, the context information may be used to recover from a system failure and continue with a migration.

Various illustrative embodiments of the present invention will now be described in detail with reference to the accompanying figures. It will be understood that the flowchart illustrations and/or block diagrams described herein can be implemented in whole or in part by dedicated hardware circuits, firmware and/or computer program instructions which are provided to a processor of a general purpose computer, special purpose computer, or other programmable data processing apparatus to produce a machine, such that the instructions (which execute via the processor of the computer or other programmable data processing apparatus) implement the functions/acts specified in the flowchart and/or block diagram block or blocks. In addition, while various details are set forth in the following description, it will be appreciated that the present invention may be practiced without these specific details, and that numerous implementation-specific decisions may be made to the invention described herein to achieve the device designer's specific goals, such as compliance with technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. In addition, some portions of the detailed descriptions provided herein are presented in terms of algorithms or operations on data within a computer memory. Such descriptions and representations are used by those skilled in the art to describe and convey the substance of their work to others skilled in the art.

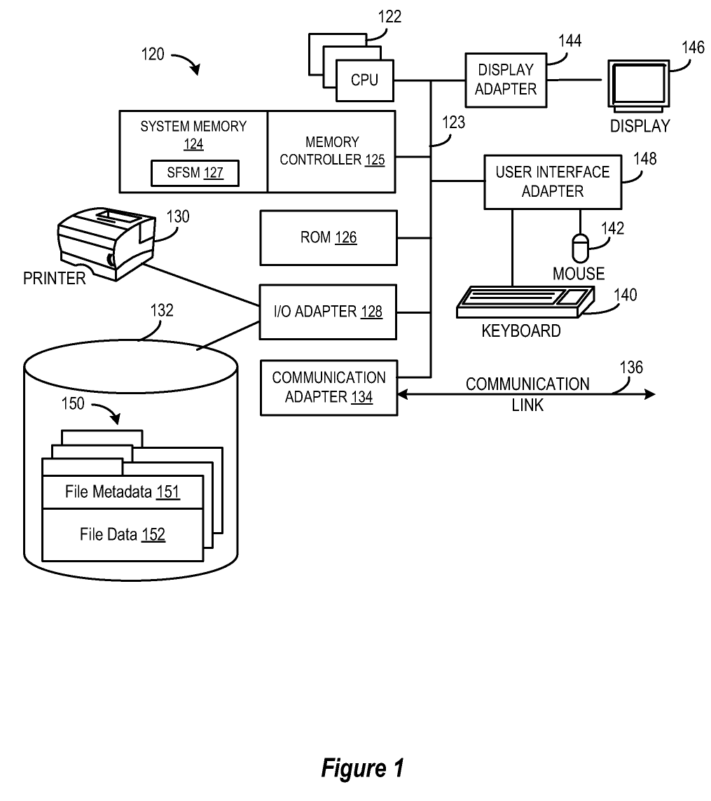

Referring to FIG. 1, an architecture of a data processing system 120 is diagrammatically depicted in which selected embodiments of the present invention may be implemented. The depicted data processing system 120 contains one or more central processing units (CPUs) 122, a system memory 124 and associated memory controller 125, and a system bus 123 that couples various system components, including the processing unit(s) 122 and the system memory 124.

System memory 124 may be implemented with computer storage media in the form of nonvolatile memory and/or volatile memory in the form of a collection of dynamic random access memory (DRAM) modules that store data and instructions that are immediately accessible to and/or presently operated on by the processing unit(s) 122. In an example implementation, the system memory 124 includes a stacked filesystem module (SFSM) 127 for managing and controlling data storage, retrieval, transformation or migration in a file system or other file-based data storage system, such as a stacked file system. The SFSM 127 may be implemented in whole or in part as part of the OS with kernel-level code, and in a selected embodiment is implemented with a kernel module component and a userspace code component, though it will be appreciated that the SFSM 127 can be stored in any memory location, including other parts of the system memory 124, the ROM 126, or even in external memory (e.g., 132). In addition, the context information and associated bitmaps or scatterlists generated by the SFSM 127 for file data 152 in a particular file 150 may be stored in any memory location that is controlled by the OS, though in selected embodiments, the context information and associated bitmaps or scatterlists are stored in external memory 132 as part of the file metadata 151 for the file 150.

The depicted system bus 123 may be implemented as a local Peripheral Component Interconnect (PCI) bus, Accelerated Graphics Port (AGP) bus, Industry Standard Architecture (ISA) bus, or any other desired bus architecture. System bus 123 is connected to a communication adapter 134 that provides access to communication link 136, a user interface adapter 148 that connects various user devices (such as keyboard 140, mouse 142, or other devices not shown, such as a touch screen, stylus, or microphone), and a display adapter 144 that connects to a display 146. The system bus 123 also interconnects the system memory 124, read-only memory 126, and input/output adapter 128 which supports various I/O devices, such as printer 130, disk unit 132, or other devices not shown, such as an audio output system, etc. The lPO adapter 128 may be implemented as a small computer system interface (SCSI) host bus adapter that provides a connection to other removable/non-removable, volatile/nonvolatile computer storage media, such as disk unit 132 which may be implemented as a hard disk drive that reads from or writes to non-removable, nonvolatile magnetic media, a tape drive that reads from or writes to a tape drive system, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

As will be appreciated, the hardware used to implement the data processing system 120 can vary, depending on the system implementation. For example, hardware or peripheral devices, such as flash read-only memory (ROM), equivalent nonvolatile memory, or optical disk drives and the like, may be used in addition to or in place of the hardware depicted in FIG. 1. In addition to being able to be implemented on a variety of hardware platforms, the present invention may be implemented in a variety of software environments so that different operating systems (such as Linux, Microsoft Windows, Microsoft Windows XP, AIX, BSD, Mac OS, HP-UX and Java-based runtime environments) are used to execute different program applications (such as a word processing, graphics, video, or browser program). In other words, while different hardware and software components and architectures can be used to implement different data processing systems (such as a Web-enabled or network-enabled communication device or a fully featured desktop workstation), such hardware or architectural examples are not meant to imply limitations with respect to the filesystem management techniques disclosed herein.

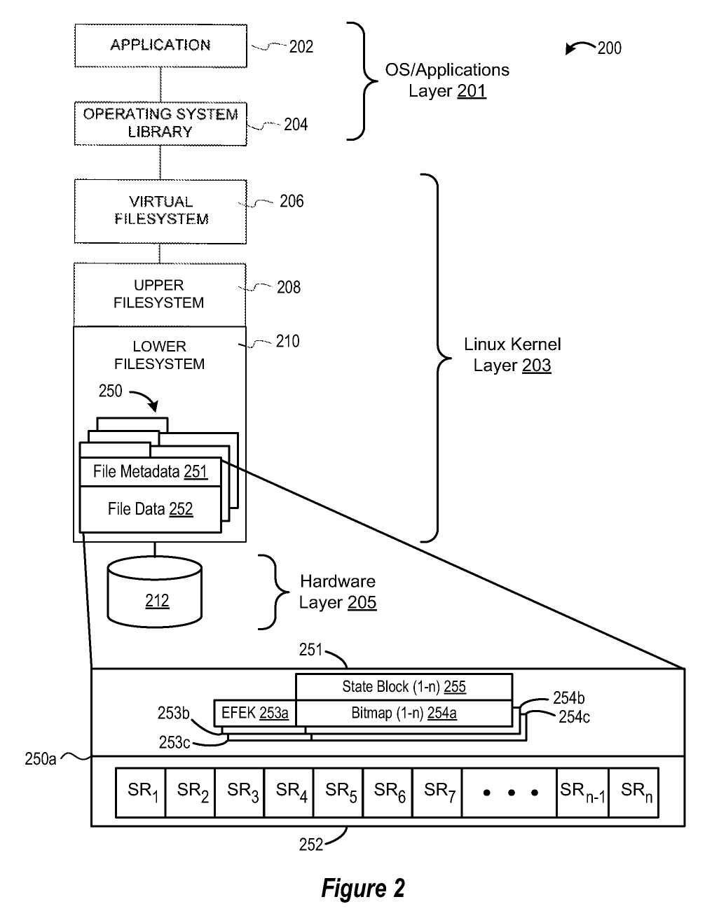

FIG. 2 depicts an example a stacked filesystem architecture for a data processing system 200 in which an upper stacked filesystem layer 208 is used to control encrypted data transformation within sub-regions (e.g., SR₁, SR₂, etc.) of the stored data files 250. The sub-regions are fixed or variable sized portions of the file data, such as an extent or page, and are used to divide the file data into separately managed and controlled sections. In the depicted example of a Linux OS implementation, the upper stacked filesystem layer 208 is implemented in the Linux kernel layer 203 which serves as an interface between the OS and applications layer 201 and the hardware layer 205 (which deals with data blocks instead of files). In turn, the OS and applications layer 201 resides above the kernel and hardware layers 203, 205, and is the basic environment for applications 202 and OS libraries 204. Of course, it will be appreciated that other types of operating systems and kernel layers may be used. In the kernel layer 203, the lower filesystem 210 collects data blocks from the storage device 212 to produce the data files 250, including the file metadata 251 and file data 252.

As shown in FIG. 2, storage device 212 is communicatively coupled with the stacked filesystem resources 208, 210 which are implemented within and/or in conjunction with the VFS 206 and operating system 204. As will be appreciated, each of the stacked filesystem resources 208, 210 contains upper files and lower files, respectively, where a file refers to the different types of objects contained in a filesystem, such as (in the case of Linux) a superblock, inode, dentry, and file. Storage device 212 may be implemented by one or more physical devices, such as hard disk drives that implement any of a number of industry standard interfaces such as ATA, SCSI, SATA, and the like, or a combination of these interfaces. Storage device 212 may be implemented with RAID type mirroring and/or data protection if desired, and may be configured as a single volume of storage or multiple volumes of storage. The storage device 212 may be coupled to the stacked filesystem 208, 210 through one or more system buses, such as a PCI bus, universal serial bus (USB), or the like. The stacked filesystem 208, 210 may be implemented with one or more underlying or lower actual filesystem drivers 210 and a single upper filesystem layer 208 (such as a virtual shim or stacked filesystem driver) that resides between the lower filesystem driver 210 and the VFS 206.

With this example architecture, a software application 202 accesses data stored in the storage device 212 by making file system calls. All file system calls pass through the Virtual File System (VFS) layer 206 and are translated by the stacked filesystem 208, 210 into bus-appropriate and interface appropriate signals which are communicated to the storage device 212. VFS 206 provides an abstract view of a wide variety of file systems supported by the operating system 204. In the stackable filesystem, an upper filesystem layer 208 is used to insert services between the VFS layer 206 and the lower filesystem layer 210, and may be used to provide a mechanism for manipulating page data and file names. For example, when implemented as part of the cryptographic filesystem, eCryptfs, the upper filesystem layer 208 can be used to provide cryptographic services for transforming file data in individual file sub-regions from a first context (e.g., DES-encrypted data) to a second context (e.g., Blowfish-encrypted data). With such cryptographic filesystems, each of the data files 250 includes a data portion (e.g., 252) for storing encrypted data and a metadata portion (e.g., 251) for storing encryption-related information, including but not limited to an encrypted file encryption key (EFEK) which is an encrypted form of the key used to encrypt the file data. In a selected embodiment, the key used to encrypt the data is itself encrypted (e.g., with an RSA or ECC public key) to form the EFEK.

To control encrypted data transformation within sub-regions (e.g., SR₁, SR₂, etc.) of a file (e.g., file 250a), the upper filesystem layer 208 creates and maintains context status information in the metadata portion 251 of the file 250 for purposes of managing and tracking the status of each context used to store data in the sub-regions. In a selected embodiment, the context status information may be implemented as a state block 255 in the metadata portion 251 of the file 250a. The state block 255 contains status or context information for each of the sub-regions in a file, so that the state block 255 contains “n” contexts, one for each of the “n” sub-regions in the file data portion 252. The context information stored in the state block 255 may be directly associated with the corresponding file sub-regions by virtue of information contained in the state block 255. Alternatively, additional tracking data structures (such as bitmaps or scatterlists) may be used to associate context information with its corresponding sub-region. For example, FIG. 2 shows that one or more bitmap data structures 254 are included in the metadata portion 251 of the file 250a, where each bit in the n-bit bitmap corresponds to a sub-region (e.g., an extent or page) in the file data portion 252.

If all of the sub-regions SR₁-SRₙ contain data that is in a first format (e.g., all of the sub-regions are encrypted with the same key), then the metadata portion 251 contains a single bitmap 254a and associated format-related information for that first format 253a. The format-related information can include an EFEK 253a, which is an encrypted version of the key used to encrypt the data, as well as other metadata, such as owner, key size, content type and checksum. In the bitmap 254a, each bit is set (or alternatively, reset) to indicate that the corresponding sub-region is in the first format. However, if different file sub-regions contain data that is formatted differently, then the metadata portion 251 contains additional bitmaps, one for each format. For example, if the sub-regions SR₁-SR₂ contain data that is in either a first or second format (e.g., sub-region 1 contains data encrypted with a first DES key and sub-region 2 contains data encrypted with a second Blowfish key), then the metadata portion 251 contains a two bitmaps 254a, 254b, each of which is associated with its respective format-related information 253a, 253b (e.g., encrypted versions of the first DES key and second Blowfish key). In the first bitmap 254a, the bits are set for those sub-regions (e.g., SR₁) containing data in the first format and are reset for those sub-regions (e.g., SR₂) containing data that is not in the first format. Likewise, in the second bitmap 254b, the bits are set for those sub-regions (e.g., SR₂) containing data in the second format and are reset for those sub-regions (e.g., SR₁) containing data that is not in the second format. As will be appreciated, additional formats can be separately managed and controlled by including additional tracking data structures (e.g., 254c) and associated format-related information (e.g., 253c), allowing any number of different data keys and/or data encryption formats to be used in encrypting the file data. On the other hand, if only two formats need to be tracked, then a single bitmap data structure could be used to identify sub-regions in the first format with the set bits and to separately identify sub-regions in the second format with the re-set bits.

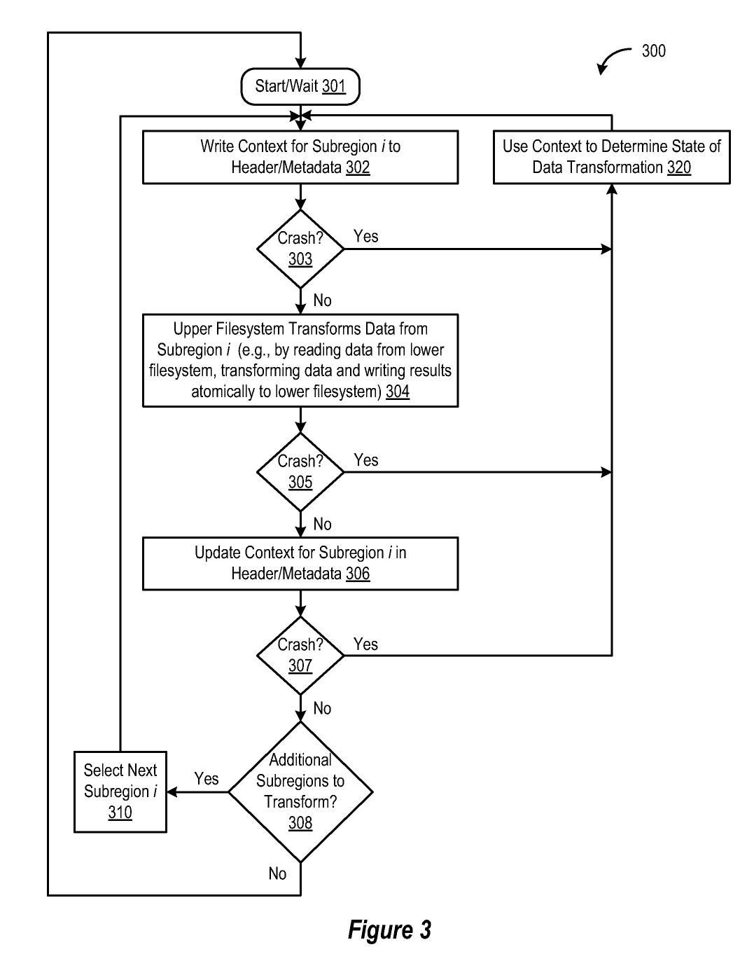

To illustrate how the sub-region status information contained in the metadata can be used to control data transformation and recovery within sub-regions of a file, reference is now made to the process flow 300 depicted in FIG. 3. Starting at step 301, data transformation is initiated when, for example, a stacked filesystem receives a request from an application to migrate data in a file from a first format to a second destination format. For example, the request may specify that a file encrypted with the weaker DES encryption cipher is the re-encrypted with the stronger destination cipher, such as a Blowfish or AES cipher, in order to enhance security. However, to allow the file to be opened for access by other applications during the migration, the transformation process is selectively applied to the file on a sub-region by sub-region basis. This may be done by tracking the migration status for each sub-region with context status information that is stored in the metadata portion of the file, and locking out only the sub-region that is in the process of being migrated.

To control the migration process within a file to lock only the sub-region in the file while it is being migrated (e.g., read, decrypted with the DES context, encrypted with the Blowfish context, and written back out to disk), a first sub-region “i” of the file to be migrated is selected and context information is written in the header or metadata portion of the file (step 302). The context information being written for the selected sub-region will provide an indication that the selected sub-region is in the process of being migrated and may also lock the sub-region from being accessed by any other application. At this initial point, the context information for a file may also include an encrypted version of the DES file encryption key used to encrypt the data, and bit vectors to identify which sub-regions are initially encrypted with the DES context. At step 302, the context information may also be initialized to include an encrypted version of the Blowfish file encryption key used to encrypt the data, and bit vectors to identify which sub-regions are initially encrypted with the Blowfish context. As a result, the initialized context information includes an encrypted file encryption key and a bit vector for the source context (e.g., DES), and a separate encrypted file encryption key and a bit vector for the destination context (e.g., Blowfish), and may also include status information indicating the encryption status for each sub-region.

As will be appreciated, the size of the bit vector will depend on the size of the sub-region, since each bit in each bit vector corresponds with a sub-region in the file. If the sub-region is a 4 KB page and the file size is 150 MB, then there are 38,400 4 KB sub-regions in the file, which would require 4,800 bytes of storage to represent a single context for all sub-regions in the file. Two contexts would require 9,600 bytes of storage. If the storage requirements for the bit vectors are more stringent, then the size of a sub-region can be increased to decrease the number of bits required to encode the regions of the file. However, with larger sized sub-regions, this means that more of the file is locked at any given time, which can adversely affect on the performance of the application, depending on the access patterns for the file.

After the context information for the selected sub-region is initialized to indicate that a migration us underway, the upper filesystem layer then performs the requested migration on the sub-region (step 304). With reference to the re-encryption example described herein, the migration may be implemented by reading the DES-encrypted data from lower filesystem, using the associated DES key to decrypt the data, using the Blowfish key to transform the data into Blowfish-encrypted data, and writing results atomically to lower filesystem. However, other data transformations can be performed, such as (de)compressing data or (re)formatting data. After a sub-region has been migrated at step 304, the context for that sub-region is updated and stored in the header or metadata portion of the file (step 306). At this point, the context information for a file may include two bitmaps, including a first bitmap with bits set to indicate which sub-regions are encrypted with the DES context, and a second bitmap with bits set to indicate which sub-regions are encrypted with the Blowfish context. With two bitmaps, the bit in the DES context bitmap is set to 0 (indicating that the context for the sub-region is not DES), and the corresponding bit in the Blowfish context bitmap is set to 1 (indicating that the context for the sub-region is Blowfish). During the update step 306, the context update may also provide an indication that the requested migration is completed for the selected sub-region and may also unlock the sub-region to allow pending operations on the sub-region to continue under the correct context.

If there are additional sub-regions in the file to be migrated (affirmative outcome to decision 308), the next available sub-region in the file is selected (step 310) and process goes back to step 302 and repeats. As will be appreciated, any desired technique may be used to select the next sub-region in the file for processing at step 310. For example, the sub-regions in a file may be selected in sequence until the entire file is migrated. If a particular sub-region is locked by another application while the file is being migrated, the transformation operation for the locked sub-region can be placed in a queue and the process can proceed to the next sub-region. When a sub-region is subsequently unlocked, a message is sent to the pending operations on the queue, and the operation for the sub-region that was unlocked can be “woken up” by a scheduler to obtain the lock, migrate the page, and modify the bit vectors accordingly. On the other hand, if there are no additional sub-regions in the file to be migrated (negative outcome to decision 308), the process returns to a wait state until another migration request is started (step 301).

By using bitmap data structures and associated context information, individual sub-regions within a file can be separately controlled and accessed. Where a file is divided into separately controlled pages, an incoming request to access a page in a file may be processed by a stacked filesystem (such as eCryptfs) by referencing the bit in each bitmap that corresponds to the selected page. If a bitmap has the corresponding bit set to 1, then the stacked filesystem uses the cryptographic context (e.g., the EFEK) associated with that bitmap to access the page. It will also be appreciated that the bit vectors do not need to be the same size. For example, if an AES context bit vector has half as many bits as a DES context bit vector, then the locking mechanism for two AES-encrypted sub-regions will not release until after the two corresponding pages for the DES context have been migrated and the two bits in the DES context bit vector set to 0.

As an alternative to using bitmap tracking data structures, individualized control and tracking of sub-regions may be implemented by storing scatterlists in the metadata to match a context with contiguous file regions based on scatterlist properties. With this approach, the data is organized such that each context maintains a list of scatterlist elements, where each scatterlist element contains an offset and a length that are used to delineate a variable-size sub-region of the file. A set of scatterlists cover the entire file. Suppose that a file is being migrated from a DES context to a Blowfish context. If this migration occurs linearly (e.g., from the beginning of the file to the end of the file) and if sub-regions of the file are not being locked by other applications, then only two scatterlist objects are necessary—one to define the region from the start of the file to the current sub-region being migrated, and another from the current sub-region being migrated to the end of the file. As contiguous sub-regions of the file are locked by other applications and as the stacked filesystem moves on to other sub-regions, the stacked filesystem creates new scatterlist objects to encode the sub-regions.

By defining the context information that is stored in the file metadata to correlate with the migration status for the sub-region, consistency problems caused by mid-migration system failures can be reduced or eliminated. In filesystems which operate on a page-atomic basis—either an entire sub-region is written out at any given time, or nothing is written out at all—the context information initialized at step 203 may include pre-migration status information identifying the state of the sub-region data prior to migration to help recover from a system crash that occurs during migration. To provide an illustrative example, before migrating sub-region N. the context information written for sub-region N at step 302 includes pre-migration status information indicating that “We are in the process of migrating sub-region N from context A to context B” and also includes a hash value M which is the MD5 sum of sub-region N in context A. Of course, any desired hash algorithms may be used to provide a fingerprint of the region that is under migration, including but not limited to MD5, SHA-1, Whirlpool, RIPEMD160, SHA-256, and the like. With this pre-migration status information stored in the metadata, the migration status can be determined (step 320) during recovery if there is a subsequent system crash that occurs before the context information is updated. In particular, if there is a system crash after writing the initial context information (affirmative outcome to crash detection steps 303, 305, 307), then on recovery, the MD5 sum of the sub-region in question can be compared against the stored MD5 sum from the metadata for that sub-region. If the MD5 sums match, this indicates that the sub-region is still in context A and has not bee migrated. On the other hand, if the MD5 sums do not match, this indicates that the sub-region was successfully migrated (due to the atomic writing property), and the context information can be updated accordingly so that the context B bit vectors for that sub-region are set.

In filesystems which are not guaranteed to operate on a page-atomic basis, the pre-migration status information may be provided by using a scratch pad memory—such as an extra “scratch” page in the file—to temporarily store the pre-migration contents of the sub-regio being migrated for use in recovery in the event of system failure. To provide an illustrative example, a copy of page N is written to the scratch page and committed before beginning the migration of page N in a file. Upon verifying that the entire scratch page has been written out, the context information written for page N at step 302 includes pre-migration status information indicating that “We are in the process of migrating page N from context A to context B.” If there is a system crash after writing the initial context information (affirmative outcome to crash detection steps 303, 305, 307), then on recovery, the migration proceeds by using the data stored in the scratch page (which contains page N in context A).

As will be appreciated by one skilled in the art, the present invention has been described in the context of an exemplary fully functioning data processing system, but may be embodied in whole or in part as a method, system, or computer program product. Furthermore, the present invention may take the form of a computer program product or instructions on a computer readable medium having computer-usable program code embodied in the medium. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. In addition, the present invention may take the form of an entirely software embodiment (including firmware, resident software, micro-code, etc.), an entirely hardware embodiment, or an embodiment combining software and hardware aspects that may all generally be referred to herein as a “circuit,” “module” or “system.” For example, the functions of time epoch module may be implemented in software instructions or program code stored in the kernel layer of a data processing system.

The foregoing description has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification and example implementations provide a complete description of the manufacture and use of the composition of the invention. Since many embodiments of the invention can be made without departing from the spirit and scope of the invention, the invention resides in the claims hereinafter appended.

What is claimed is:

1. A method for selectively managing data migration in a stacked filesystem, comprising:
receiving a request to migrate a data file to a destination context, where the data file comprises a plurality of sub-regions such that data stored in different sub-regions may have different contexts; and
sequentially migrating data in the data file, one sub-region at a time, to the destination context by maintaining context status information for each sub-region in a metadata portion of the data file, where the context status information prevents another application from accessing any sub-region in the data file that is being migrated, but allows access to other sub-regions in the data file.

2. The method of claim 1, where the context status information in the metadata portion of the data file comprises:
a state block comprising encryption status information for each sub-region of the data file;
an encrypted file encryption key for each encryption format used to encrypt data that is stored in the plurality of sub-regions; and
a tracking data structure for each encryption format used to encrypt data that is stored in the plurality of sub-regions, where the tracking data structure for a first encryption format identifies which sub-regions store data that is encrypted with the first encryption format.

3. The method of claim 1, where the step of sequentially migrating data comprises:
retrieving encrypted data from a selected sub-region that is encrypted with a first encryption format;
decrypting the encrypted data into unencrypted data using context status information associated with the selected sub-region;
encrypting the unencrypted data into reencrypted data with a second encryption format specified by the destination context; and
storing the reencrypted data in the selected sub-region of the data file.

4. The method of claim 1, where the step of sequentially migrating data comprises:
retrieving uncompressed data from a selected sub-region;
compressing the uncompressed data into compressed data using context status information associated with the selected sub-region; and
storing the compressed data in the selected sub-region of the data file.

5. The method of claim 1, where each sub-region of the data file comprises a data file extent.

6. The method of claim 1, where maintaining context status information for each sub-region in a metadata portion of the data file comprises:
storing a context bitmap in a metadata portion of the data file for each context used to stored data in the plurality of sub-regions, where each bit in the context bitmap corresponds uniquely to one of the plurality of sub-regions.

7. The method of claim 1, where maintaining context status information for each sub-region in a metadata portion of the data file comprises:
storing a context scatterlist in a metadata portion of the data file for each context used to stored data in the plurality of sub-regions, where each context scatterlist element uniquely delineates one of the plurality of sub-regions.

8. The method of claim 1, further comprising:
detecting a system failure during migration of a selected sub-region; and
recovering from the system failure by using context status information associated with the selected sub-region to complete migration of the selected sub-region.

9. A computer-usable medium embodying computer program code, the computer program code comprising computer executable instructions configured for selectively managing data migration in a stacked filesystem by:
receiving a request to migrate a data file to a destination context, where the data file comprises a plurality of sub-regions such that data stored in different sub-regions may have different contexts; and
sequentially migrating data in the data file, one sub-region at a time, to the destination context by maintaining context status information for each sub-region in a metadata portion of the data file, where the context status information prevents another application from accessing any sub-region in the data file that is being migrated, but allows access to other sub-regions in the data file.

10. The computer-usable medium of claim 9, where the context status information in the metadata portion of the data file comprises:
a state block comprising encryption status information for each sub-region of the data file;
an encrypted file encryption key for each encryption format used to encrypt data that is stored in the plurality of sub-regions; and
a tracking data structure for each encryption format used to encrypt data that is stored in the plurality of sub-regions, where the tracking data structure for a first encryption format identifies which sub-regions store data that is encrypted with the first encryption format.

11. The computer-usable medium of claim 9, wherein the computer executable instructions are configured to sequentially migrate data in the data file by:
retrieving encrypted data from a selected sub-region that is encrypted with a first encryption format;
decrypting the encrypted data into unencrypted data using context status information associated with the selected sub-region;
encrypting the unencrypted data into reencrypted data with a second encryption format specified by the destination context; and
storing the reencrypted data in the selected sub-region of the data file.

12. The computer-usable medium of claim 9, wherein the computer executable instructions are configured to sequentially migrate data in the data file by:
retrieving uncompressed data from a selected sub-region;
compressing the uncompressed data into compressed data using context status information associated with the selected sub-region; and
storing the compressed data in the selected sub-region of the data file.

13. The computer-usable medium of claim 9, wherein the computer executable instructions are configured to maintaining context status information for each sub-region in a metadata portion of the data file by storing a context bitmap in a metadata portion of the data file for each context used to stored data in the plurality of sub-regions, where each bit in the context bitmap corresponds uniquely to one of the plurality of sub-regions.

14. The computer-usable medium of claim 9, wherein the computer executable instructions are configured to maintaining context status information for each sub-region in a metadata portion of the data file by storing a context scatterlist in a metadata portion of the data file for each context used to stored data in the plurality of sub-regions, where each context scatterlist element uniquely delineates one of the plurality of sub-regions.

15. The computer-usable medium of claim 9, wherein the computer program code further comprises computer executable instructions configured for detecting a system failure during migration of a selected sub-region, and recovering from the system failure by using context status information associated with the selected sub-region to complete migration of the selected sub-region.

16. A data processing system comprising:
a processor;
a data bus coupled to the processor; and
a computer-usable medium embodying computer program code, the computer-usable medium being coupled to the data bus, the computer program code comprising instructions executable by the processor and configured for selectively managing data migration in a stacked filesystem by:
receiving a request to migrate a data file to a destination context, where the data file comprises a plurality of sub-regions such that data stored in different sub-regions may have different contexts; and
sequentially migrating data in the data file, one sub-region at a time, to the destination context by maintaining context status information for each sub-region in a metadata portion of the data file, where the context status information prevents another application from accessing any sub-region in the data file that is being migrated, but allows access to other sub-regions in the data file.

17. The data processing system of claim 16, where the context status information in the metadata portion of the data file comprises
a state block comprising encryption status information for each sub-region of the data file;
an encrypted file encryption key for each encryption format used to encrypt data that is stored in the plurality of sub-regions; and
a tracking data structure for each encryption format used to encrypt data that is stored in the plurality of sub-regions, where the tracking data structure for a first encryption format identifies which sub-regions store data that is encrypted with the first encryption format.

18. The data processing system of claim 16, wherein the computer program code further comprises computer executable instructions configured for:
retrieving encrypted data from a selected sub-region that is encrypted with a first encryption format;
decrypting the encrypted data into unencrypted data using context status information associated with the selected sub-region;
encrypting the unencrypted data into reencrypted data with a second encryption format specified by the destination context; and
storing the reencrypted data in the selected sub-region of the data file.

19. The data processing system of claim 16, wherein the computer program code further comprises computer executable instructions configured for:
retrieving uncompressed data from a selected sub-region;
compressing the uncompressed data into compressed data using context status information associated with the selected sub-region; and
storing the compressed data in the selected sub-region of the data file.

20. The data processing system of claim 16, wherein the computer program code further comprises computer executable instructions configured for:
detecting a system failure during migration of a selected sub-region; and
recovering from the system failure by using context status information associated with the selected sub-region to complete migration of the selected sub-region.
